(19) United States
(12) Patent Application Publication
(10) Pub. No.: US 2026/0309187 A1
(43) Pub. Date: Oct. 8, 2026

(54) BEARING DEVICE WITH INTEGRATED ELECTRICAL INSULATION, IN PARTICULAR FOR A MOTOR OR ELECTRIC MACHINE, AND OPTIMIZED GROOVE

(71) Applicant: AKTIEBOLAGET SKF, GOTEBORG (SE)

(72) Inventors: Benoit ARNAULT, Saint-Cyr-sur-Loire (FR); Mickael CHOLLET, Joué-Lès-Tours (FR)

(21) Appl. No.: 19/631,679

(22) Filed: Mar. 27, 2026

(30) Foreign Application Priority Data
Apr. 4, 2025 (FR) FR2503532

(51) Int. Cl. F16C 19/52; F16C 41/00

(52) U.S. Cl. CPC F16C 19/52; F16C 41/002; F16C 2226/00; F16C 2380/26

(57) ABSTRACT

A bearing device includes a bearing having first and second rings, a bushing, and an electrically insulating insert overmolded between the bushing and the second bearing ring. The bushing is formed from two cylindrical parts that meet at a joint, and a radial thickness of the bushing in a joint zone on either side of the joint is less than a radial thickness of the cylindrical parts outside the joint zone such that a groove is formed in the bushing in the joint zone on a side of the bushing opposite the electrically insulating insert.

### CROSS-REFERENCE

This application claims priority to French patent application no. FR2503532 filed on Apr. 4, 2026, the contents of which are fully incorporated herein by reference.

### TECHNOLOGICAL FIELD

The present disclosure relates to the field of bearings used particularly in electric motors, electric machines and associated equipment.

### BACKGROUND

In a motor or electric machine, at least one roller bearing is mounted between the housing of the motor or electric machine and the rotary shaft in order to support the shaft and provide precise guidance of the rotation thereof. During operation, the mechanical forces and thermal stresses applied to the bearing can cause local deformation, in particular at the assembly interfaces between the components of the bearing. This deformation can result in excessive play, alignment defects or premature wear, thus affecting the performance and service life of the bearing.

In order to improve the robustness of the bearings and limit these undesirable effects, it is known practice to provide the outer ring of the bearing with an insulating sleeve comprising a bushing made in two parts and an insulating liner radially interposed between the outer ring and the bushing. This solution makes it possible to provide effective electrical insulation and limit the transfer of the electric currents through the components of the bearing, thus reducing the risk of damage to the raceways and the rolling elements. However, fitting the bearing device inside the opening of the motor housing can be problematic.

This is because during the fitting of the bearing device into the opening of the motor housing, the first part of the bushing of the device is compressed by the contact with the opening of the motor housing. The free edge of the second part of the bushing then protrudes radially outwards and can jam against the opening of the motor housing when the user continues to push the bearing device axially inside the opening of the motor housing. This can make it difficult to fit the bearing device and also result in local concentrations of stresses in the joint zone between the two parts of the bushing.

### SUMMARY

The disclosure relates to a bearing device comprising a first ring and a second ring configured to rotate relative to each other, and an insulating sleeve fitted onto the second ring of the bearing and provided with a bushing and an insulating liner radially interposed between the second ring and the bushing and made from an electrically insulating material.

According to one general feature, the bushing comprises an outer surface and an inner surface opposite the outer surface that define the radial thickness of the bushing, the insulating liner being overmolded on the second ring of the bearing and at least on one of the outer and inner surfaces of the bushing.

According to another general feature, the bushing is made in two different parts, each part comprising at least one axial portion, the axial portions of the two parts of the bushing being in axial contact with each other in a joint zone and together defining the outer surface and the inner surface of the bushing.

According to another general feature, the axial portions of the two parts of the bushing together define an annular groove in the joint zone between the axial portions that is open radially on the opposite side from the insulating lining.

The fitting of the bearing device inside the opening of the associated motor housing is thus facilitated by preventing the formation of sharp edges in the joint zone between the axial portions of the two parts of the bushing during fitting. The risk of the occurrence of local concentrations of stresses in the joint zone between the two parts of the bushing during the fitting of the bearing device is thereby reduced.

Preferably, each axial portion of the two parts of the bushing has a front face, an outer or inner surface that partially defines the other surface of the inner and outer surfaces of the bushing, and a profiled part extending between the outer or inner surface and the front face, the front faces of the axial portions of the two parts being in axial contact with each other and the profiled parts of the axial portions together defining the groove.

According to a first design, the profiled part of each axial portion of the two parts of the bushing comprises a bevel inclined relative to the axis of the bushing. According to a second design, the profiled part of each axial portion of the two parts of the bushing comprises a convex section. According to a third design, the profiled part of each axial portion of the two parts of the bushing comprises a cylindrical surface connecting to the front face and a frustoconical surface widening out from the cylindrical surface and connecting to the outer or inner surface.

The two parts of the bushing are advantageously symmetrical relative to a radial mid-plane of the bearing device. In one particular embodiment, each part comprises a radial collar radially extending from the axial portion towards the second ring.

The disclosure also relates to a method for manufacturing a bearing device as defined above, comprising: a step of fitting one of the parts of the bushing in the bottom of a manufacturing mold, a step of placing the second ring inside the manufacturing mold, a step of fitting the other of the parts of the bushing inside the manufacturing mold, a step of overmolding the insulating liner on the second ring and at least on the annular outer surface of the bushing, a step of extracting the unitary assembly formed by the second ring, the first and second parts of the bushing and the insulating liner from the manufacturing mold, and a step of assembling the assembly formed by the second ring, the parts of the bushing and the insulating liner with the first ring of the bearing.

Prior to the step of assembling the parts of the bushing, the profiled part of each axial portion of the two parts of the bushing can be formed by stamping.

The disclosure also relates to an electric motor comprising a housing, a shaft and at least one bearing device as defined above radially interposed between the housing and the shaft.

### BRIEF DESCRIPTION OF THE DRAWINGS

The present disclosure will be better understood upon reading the detailed description of embodiments given by way of non-limiting example and illustrated by the appended drawings, in which:

FIG. 1 is an axial cross sectional view of a portion of a bearing device according to an exemplary embodiment of present the disclosure.

FIG. 2 is a partially exploded perspective view of the bearing device of FIG. 1, in which an insulating liner of the device is omitted for illustration purposes.

FIG. 3 is a detail view of a portion of the device according to another embodiment of the disclosure.

FIG. 4 is a detail view of a portion of the device according to another embodiment of the disclosure.

FIG. 5 is a detail view of a portion of the device according to another embodiment of the disclosure.

FIG. 6 is a flow diagram showing a method for manufacturing the bearing device of FIG. 1.

### DETAILED DESCRIPTION

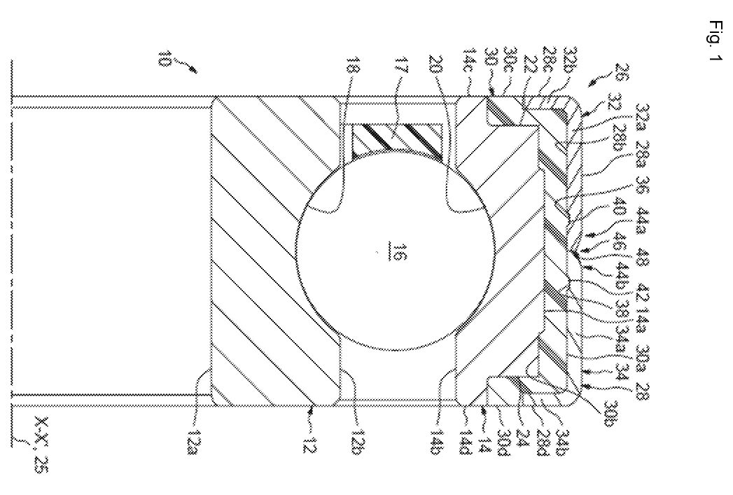

The bearing device shown in FIGS. 1 and 2 comprises a bearing 10 having a first ring 12 and a second ring 14 that are configured to rotate relative to each other about the axis X-X’ of the bearing. In the exemplary embodiment shown, the first ring 12 is the inner ring of the bearing and the second ring 14 is the outer ring. The inner and outer rings 12, 14 of the bearing are concentric and extend axially along the axis X-X’ of the bearing. The inner and outer rings 12, 14 are made from steel. The rings are of the solid type.

In the exemplary embodiment shown, the bearing 10 also comprises a row of rolling elements 16, here balls, radially interposed between the inner and outer rings 12, 14. The rolling elements 16 are made from steel. The bearing 10 also comprises a cage 17 for maintaining an even circumferential spacing of the rolling elements 16. The bearing 10 can further be provided with seals or sealing flanges.

The inner ring 12 comprises a cylindrical opening 12a, a cylindrical axial outer surface 12b radially opposite the opening, and two opposite radial front faces (not numbered) axially defining the opening and the outer surface. The opening 12a and the outer surface 12b define the radial thickness of the inner ring 12. The opening 12a forms the inner surface of the inner ring. The inner ring 12 further comprises an inner raceway 18 for the rolling elements 16, which is formed on the outer surface 12b. The raceway 18 faces radially outwards.

The outer ring 14 comprises a cylindrical axial outer surface 14a, a cylindrical opening 14b radially opposite the outer surface 14a, and two opposite radial front faces 14c, 14d axially defining the opening. The outer surface 14a and the opening 14b define the radial thickness of the outer ring 14. In the exemplary embodiment shown, the outer surface 14a of the ring has two different diameters. Alternatively, the outer surface 14a could have a single diameter. The outer ring 14 further comprises an outer raceway 20 for the rolling elements 16, which is formed on the opening 14b. The raceway 20 faces radially inwards.

The bearing device also comprises an electrically insulating sleeve 26 fitted onto the outer ring 14. The insulating sleeve 26 is fitted onto the outer surface 14a of the outer ring 14. The insulating sleeve 26 is rigidly connected to the outer ring 14. The insulating sleeve 26 comprises a bushing 28 and an insulating liner 30 radially interposed between the outer ring 14 and the bushing 28. The insulating liner 30 is overmolded on the outer ring 14 and on the bushing 28.

The bushing 28 is annular and consists of two different and separate parts 32, 34 forming half-flanges that are in axial contact with each other here. In the exemplary embodiment shown, the parts 32, 34 of the bushing are identical and symmetrical relative to a radial mid-plane in order to reduce manufacturing costs. Alternatively, non-symmetrical parts 32, 34 can of course be used. In another variant, the bushing 28 could be formed with more than two parts. Preferably, the parts 32, 34 of the bushing 28 are made from steel. The parts 32, 34 can advantageously be obtained from a sheet metal blank by cutting, stamping and rolling. Alternatively, the parts 32, 34 can be obtained from a tube or from forged and/or rolled blanks, using methods such as sintering or stamping, or by machining, particularly when precise and/or complex shapes are required.

Each part 32, 34 of the bushing comprises an annular axially extending portion 32a, 34a, and a radially extending collar 32b, 34b extending radially inwards from the axial portion 32a, 34b. The axial portions 32a, 34a are in axial contact with each other. The radial collar 32b, 34b extends the end of the axial portion 32a, 34a situated axially on the outside of the device. In the exemplary embodiment shown, the radial collars 32b, 34b are annular. Alternatively, at least one of the radial collars 32b, 34b could take the form of sectors spaced apart from each other in the circumferential direction.

The bushing 28 comprises a cylindrical axial outer surface 28a, and a cylindrical opening 28b radially opposite the outer surface 28a, the axis 25 of which is coaxial with the axis X-X’. The opening 28b forms the inner surface of the bushing 28. The axial portions 32a, 34a of the parts of the bushing 28 together define the outer surface 28a. Similarly, the axial portions 32a, 34a of the parts together define the opening 28b. The outer surface 28a and the opening 28b define the radial thickness of the bushing 28. The outer surface 28a of the bushing forms the outer surface of the bearing device 10. In other words, the outer surface 28a defines the outer diameter of the bearing device 10.

The bushing 28 also comprises two opposite radial front faces 28c, 28d axially defining the outer surface 28a. The front faces 28c, 28d define the axial length of the bushing. The front face 28c is defined by the radial collar 32b, and the front face 28d is defined by the radial collar 34b. More specifically, the front face 28c is defined by the outer face of the radial collar 32b, and the front face 28d is defined by the outer face of the radial collar 34b.

In the exemplary embodiment shown, the front faces 28c, 28d of the bushing are respectively coplanar with the front faces 14c, 14d of the outer ring. Alternatively, other arrangements could be envisaged. For example, the bushing 28 could have a smaller, or larger, axial dimension and be axially set back from the faces 14c, 14d of the outer ring, or protruding from the faces.

In the exemplary embodiment shown, the radial collars 32b, 34b of the parts of the bushing extend radially beyond the outer surface 14a of the outer ring, i.e. protruding radially inwards relative to the outer surface 14a. In other words, the free ends of the radial collars 32b, 34b are offset radially inwards relative to the outer surface 14a of the outer ring. The radial collars 32b, 34b remain at a distance from (are spaced from) the inner ring 12. Alternatively, the radial collars 32b, 34b could have a radial dimension. In another variant, at least one of the two parts of the bushing could be formed without a radial collar.

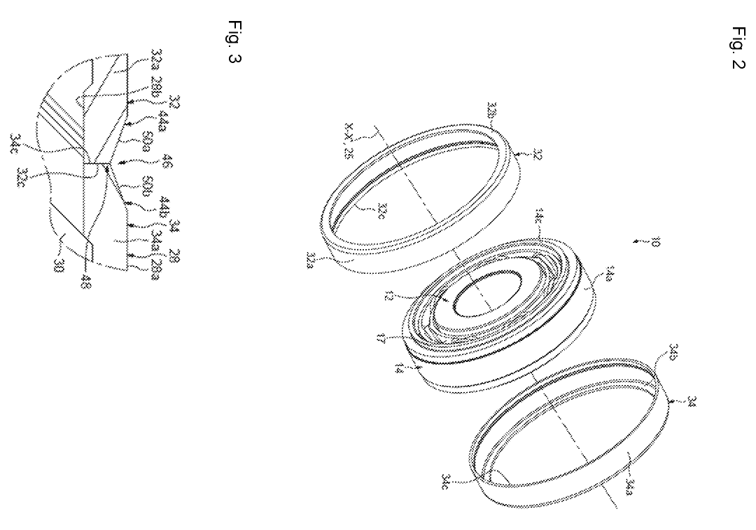

As stated above, the axial portions 32a, 34a of the two parts of the bushing are in axial contact with each other. Each axial portion 32a, 34a has a front face 32c, 34c (e.g., FIG. 3) at its free end. Each front face 32a, 34a defines, with the front face 28c, 28d of the radial collar 32b, 34b, the axial length of the associated part of the bushing. The front face 32c of the axial portion 32a is in axial contact with the front face 34c of the axial portion 34a in a joint zone 48 between the axial portions 32a, 34a of the two parts of the bushing.

Each axial portion 32a, 34a also has an outer surface and an inner surface (not numbered), and a profiled part 44a, 44b extending between the outer surface and the front face 32c, 34c. The profiled part 44a, 44b of each axial portion 32a, 34a connects the outer surface of the axial portion 32a, 34a to the front face 32c, 34c. The inner surfaces of the axial portions 32a, 34a together define the opening 28b of the bushing. The outer surfaces and the profiled parts 44a, 44b of the axial portions 32a, 34a together define the outer surface 28a of the bushing.

The axial portions 32a, 34a of the two parts of the bushing together define a groove 46 in the joint zone 48 between the axial portions 32a, 34a. More specifically, the profiled parts 44a, 44b together define the groove 46. The groove 46 is open radially on the opposite side from the insulating liner 30, i.e. radially on the outside.

In the exemplary embodiment shown in FIG. 3, each profiled part 44a, 44b has a frustoconical bevel 50a, 50b that connects directly to the outer surface of the axial portion 32a, 34a and to the front face 32c, 34c. Each bevel 50a, 50b is inclined relative to the axis of the bushing.

As a variant, the profiled parts 44a, 44b of the axial portions of the two parts of the bushing can have other configurations. For example, in the exemplary embodiment shown in FIG. 4, in which identical elements have the same reference signs, each profiled part 44a, 44b has a convex section 52a, 52b that connects directly to the outer surface of the axial portion 32a, 34a and to the front face 32c, 34c.

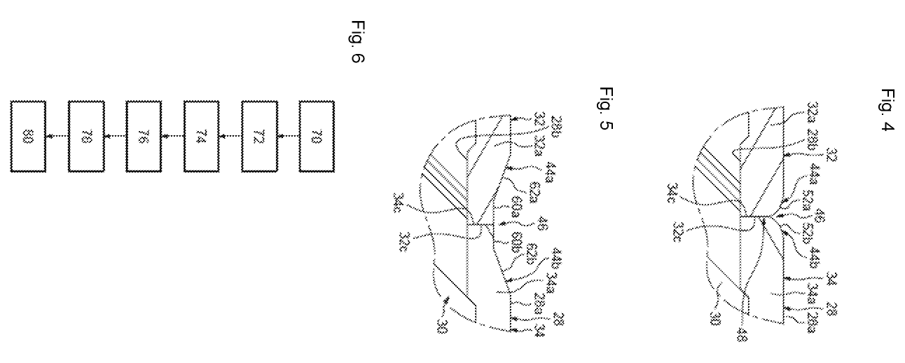

In another variant shown in FIG. 5, in which identical elements have the same reference signs, each profiled part 44a, 44b of the axial portions of the two parts of the bushing has a cylindrical surface 60a, 60b connecting to the front face 32c, 34c, and a flared frustoconical surface 62a, 62b widening out from the cylindrical surface 60a, 60b and connecting to the outer surface of the axial portion 32a, 34a.

The insulating liner 30 is radially interposed between the outer surface 14a of the outer ring and the opening 28b of the bushing. The insulating liner 30 covers the outer surface 14a of the outer ring. Here, the insulating liner 30 entirely covers the outer surface 14a in the axial and circumferential directions.

The insulating liner 30 also covers the opening 28b of the bushing 28. Here, the insulating liner 30 also entirely covers the opening 28b in the axial and circumferential directions. The insulating liner 30 covers the opening of the axial portion 32a, 34a of each part 32, 34 of the bushing. The insulating liner 30 also covers the inner face of the radial collar 32b, 34b of each part 32, 34 of the bushing and the free end of the radial collar 32b, 34b of each part 32, 34 of the bushing 28.

The insulating liner 30 is annular. The insulating liner 30 extends axially. The insulating liner 30 comprises a cylindrical axial outer surface 30a, a cylindrical opening 30b radially opposite the outer surface 30a, and two opposite radial front faces 30c, 30d axially defining the opening and the outer surface. The radial front faces 30c, 30d axially define the insulating liner 30. The outer surface 30a and the opening 30b define the radial thickness of the insulating liner 30. The outer surface 30a is in radial contact with the opening 28b of the bushing. The outer surface 30a is also in radial contact with the free end of the radial collar 32b, 34b of each part 32, 34 of the bushing. The outer surface 30a has a stepped shape. The opening 30b is in radial contact with the outer surface 14a of the outer ring. The opening 30b has a stepped shape.

In the embodiment shown, the faces 14c, 30c, 28c and 14d, 30d, 28d of the outer ring, of the insulating liner and of the bushing are respectively coplanar.

The insulating liner 30 also comprises two ribs 40, 42 extending radially outward from the outer surface 30a and each extending inside grooves 36, 38 formed on the opening of the axial portion 32a, 34a of the parts 32, 34 of the bushing. Each rib 40, 42 extends protruding from the outer surface 30a of the insulating lining. Each rib 40, 42 is formed on the outer surface 30a during the overmolding of the insulating liner 30.

The insulating liner 30 is made from an electrically insulating material. The insulating liner 30 can for example be made from a synthetic material, such as PEEK or PA46, or be made from an elastomer material, for example rubber.

In order to manufacture the bearing device 10, the following steps are carried out. In a first step 70 shown schematically in FIG. 6, the first part 32 of the bushing is fitted inside a mold provided for overmolding the insulating liner 30. In a successive second step 72, the outer ring 14 is placed inside the mold. Then, in a third step 74, the second part 34 of the bushing is fitted inside the mold in axial contact with the first part 32. In this position fitted inside the mold, the first part 32 and the second part 34 of the bushing are radially at a distance from the outer ring 14. The first and second parts 32, 34 of the bushing are formed by stamping prior to being fitted inside the manufacturing mold. Then, in a successive fourth step 76, the insulating liner 30 is overmolded on both the outer ring 14 and the first and second parts 32, 34 of the bushing 28. The ribs 40, 42 of the insulating liner 30 are formed during this step.

In a successive fifth step 78, the unitary assembly formed by the outer ring 14, the first and second parts 32, 34 of the bushing 28, and the insulating liner 30, is extracted from the mold. Then, in a successive sixth step 80, the unitary assembly formed by the outer ring 14, the first and second parts 32, 34 of the bushing 28, and the insulating liner 30, is assembled with the row of rolling members 16, the cage 17 and the inner ring 12. In the exemplary embodiments shown, the first ring 12 of the bearing is the inner ring and the second ring 14 on which the insulating liner 30 is overmolded is the outer ring.

Alternatively, a reverse arrangement can be provided in which the second ring 14 on which the insulating liner 30 is overmolded is the inner ring. In this case, the insulating sleeve 26 is situated in the opening 12a of the inner ring. The insulating liner 30 is then radially interposed between the opening 12a of the inner ring and the outer surface of the bushing 28. The insulating liner 30 is overmolded on the inner ring and at least on the outer surface of the bushing 28. The opening of the bushing 28 defines the opening 28b of the bearing device 10. In this variant, the groove delimited by the axial portions of the two parts 32, 34 of the bushing in the joint zone between them is radially open on the inside, and therefore remains radially open on the opposite side from the insulating liner 30.

In the exemplary embodiments described, the bearing of the device 10 is provided with a single row of rolling elements. As a variant, the bearing can be provided with a plurality of rows of rolling elements. In addition, the roller bearing can comprise other types of rolling element apart from balls, for example rollers. In another variant, the bearing can be a plain bearing, without rolling elements.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved insulated bearing devices.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A bearing device comprising:
a bearing including a first ring and a second ring configured to rotate relative to each other about a central axis, the second ring having a first cylindrical surface and a second cylindrical surface radially spaced from the first cylindrical surface,
a bushing, and
an electrically insulating insert overmolded between and connecting the bushing and the second cylindrical surface of the second ring,
wherein the bushing comprises a first part having an axially extending first cylindrical portion having a radial thickness from a first surface to a second surface radially spaced from the first surface and a first front face at a first axial end of the first cylindrical portion and the bushing comprises a second part having an axially extending second cylindrical portion having a radial thickness from a first surface to a second surface radially spaced from the first surface of the second cylindrical portion and a second front face at a second axial end of the second cylindrical portion, the second front face being in axial contact with the first front face at a joint,
wherein the electrically insulating insert extends from the first cylindrical surface of the first part to the second cylindrical surface of the second ring and from the first cylindrical surface of the second part to the second cylindrical surface of the second ring, and
wherein the radial thickness of the bushing at the joint is less than a radial thickness of the first cylindrical portion of the first part of the bushing at a first location spaced from the joint and less than a radial thickness of the second cylindrical portion of the second part of the bushing at a second location spaced from the joint such that a groove is formed in the bushing in a joint zone on either side of the joint on a side of the bushing opposite the electrically insulating insert.

2. The bearing device according to claim 1,
wherein the first part includes a first annular collar extending radially from a second axial end of the first cylindrical portion and the second part includes a second annular collar extending radially from a second axial end of the second cylindrical portion, and
wherein the electrically insulating insert is overmolded on and extends between the first annular collar and the second annular collar.

3. The bearing device according to claim 2,
wherein the joint zone includes a profiled portion of the first part extending away from the first front face and a profiled portion of the second part extending away from the second front face, and
wherein the first profiled portion defines a first portion of the groove and the second profiled portion defines a second portion of the groove.

4. The bearing device according to claim 3,
wherein the first profiled portion includes a first conical surface and the second profiled portion includes a second conical surface.

5. The bearing device according to claim 3,
wherein the first profiled portion is convex and the second profiled portion is convex.

6. The bearing device according to claim 3,
wherein the first profiled portion comprises a cylindrical first section at the joint and a conical second section extending from the cylindrical first part, and
wherein the second profiled portion comprises a cylindrical first section at the joint and a conical second section extending from the cylindrical first section of the second profiled portion.

7. The bearing device according to claim 2,
wherein the radial thickness of an end of the first part located in the joint zone increases monotonically from the first front face to a first axial end of the joint zone and the radial thickness of an end of the second in the joint zone increases monotonically from the second front face to a second axial end of the joint zone.

8. The bearing device according to claim 7,
wherein the first part and the second part are symmetrical relative to a radial mid-plane of the bearing device.

9. The bearing device according to claim 2,
wherein the first part and the second part are symmetrical relative to a radial mid-plane of the bearing device.

10. An electric motor comprising:
a housing,
a shaft, and
a bearing device according to claim 2 radially interposed between the housing and the shaft.

11. A method for manufacturing a bearing device comprising:
fitting a first part of a bushing having a profiled axial end in a bottom of a manufacturing mold,
placing a first bearing ring inside the manufacturing mold,
fitting a second part of the bushing having a profiled axial end inside the manufacturing mold with the profiled axial end of the first part of the bushing in contact with the profiled axial end of the second part of the bushing,
overmolding an insulating liner onto the first bearing ring and the first part of the bushing and the second part of the bushing,
allowing the insulating liner to cure,
extracting a unitary assembly formed by the first bearing ring, the first and second parts of the bushing and the insulating liner from the manufacturing mold, and
installing the unitary assembly to a second bearing ring.
